(19) United States
(12) Patent Application Publication
(10) Pub. No.: US 2009/0145017 A1
(43) Pub. Date: Jun. 11, 2009

(54) Fishing Bait Including Fly Tying Materials

(76) Inventor: Wayne S. Richey, Mesa, AZ (US)

Correspondence Address: QUARLES & BRADY LLP, 411 E. WISCONSIN AVENUE, SUITE 2040, MILWAUKEE, WI, 53202-4497, US

(21) Appl. No.: 12/263,110

(22) Filed: Oct. 31, 2008

Related U.S. Application Data
(60) Provisional application No. 60/984,095, filed on Oct. 31, 2007.

(51) Int. Cl. A01K 91/06

(52) U.S. Cl. 43/43.14; 43/44.92

(57) ABSTRACT

A fishing bait is disclosed that comprises a frame member that includes a connection point connectable to a fishing line. The fishing bait further comprises at least one hook connected to the frame member, and the at least one hook includes at least one point. The fishing bait further comprises an imitation device for attracting fish, and the imitation device includes a head that comprises fly tying materials connected to the frame member. The fishing bait further comprises a buoyancy control device connected to the frame member proximate to and separate from the head of the imitation device.

### CROSS-REFERENCE TO RELATED APPLICATION

This application claims the benefit of U.S. Provisional Patent Application No. 60/984,095 filed Oct. 31, 2007, the disclosure of which is hereby incorporated by reference.

### STATEMENT CONCERNING FEDERALLY SPONSORED RESEARCH OR DEVELOPMENT

Not applicable.

### FIELD OF THE INVENTION

This invention relates generally to artificial fishing baits, and in particular, fly tying methods and materials are used which either imitate or suggest a food item to fish or is otherwise attractive to fish.

### BACKGROUND OF THE INVENTION

Fishing with artificial fishing baits dates to ancient Egypt, possibly when bronze hooks were first developed there in about 300 B.C. Fishing with artificial fishing baits is currently practiced world-wide by hundreds of millions of people and is a very effective method for catching fish.

In general there are two types of artificial fishing baits: “lures” and “flies.” Lures are typically differentiated from flies by the materials used, and the methods of construction employed, for manufacturing these fishing items. Lures are typically made mostly of metals, plastics, glass, and other hard materials, but may have a small amount of hair, synthetic fibers, or feathers attached. Lures are typically fished using bait casting and spinning tackle. Flies are typically made mostly from furs, feathers, synthetic fibers, and hairs, but in some instances may include spinner blades, plastic lips, or other similar items normally thought of as parts of lures. Flies are typically fished using fly fishing tackle.

Some designs exist in which components traditionally regarded as lures and flies are combined. However, such designs are considered to perform poorly due to erratic motion of the lure in water. Some users address this problem by modifying the generally symmetrical shape or “tuning” the design so that it exhibits proper motion in water. Tuning the design in such a manner can be difficult and time consuming, however.

For at least the above reasons, a need exists for artificial fishing baits that incorporate the unique and advantageous characteristics of both lures and flies while exhibiting proper motion in water.

### SUMMARY OF THE INVENTION

In one aspect, a fishing bait is provided that comprises a frame member that includes a connection point that is connectable to a fishing line. The fishing bait further comprises at least one hook connected to the frame member, and the at least one hook includes at least one point. The fishing bait further comprises an imitation device for attracting fish, and the imitation device includes a head that comprises fly tying materials connected to the frame member. The fishing bait further comprises a buoyancy control device connected to the frame member proximate to and separate from the head of the imitation device.

In another aspect, a fishing bait is provided that comprises a frame member that includes a connection point that is connectable to a fishing line, and the frame member has a keel-shape. The fishing bait further comprises at least one hook connected to the frame member, and the at least one hook includes at least one point. The fishing bait further comprises at least one lure provision connected to the frame member, and an imitation device for attracting fish. The imitation device includes fly tying materials and is shaped to complement the keel-shape of the frame member.

In yet another aspect, a fishing bait is provided that comprises a frame member that includes an eye that is connectable to a fishing line. The frame member includes a distal end opposite the eye, and the frame member has a keel-shape. The fishing bait further comprises at least one hook connected to the distal end of the frame member, and the at least one hook includes at least one point. The fishing bait further comprises an imitation device for attracting fish, and the imitation device includes a head that comprises fly tying materials that is connected to the frame member. The fishing bait further comprises a buoyancy control device connected to the frame member proximate to and separate from the head of the imitation device.

Various other features of the present invention will be made apparent from the following detailed description and the drawings.

### BRIEF DESCRIPTION OF THE DRAWINGS

The invention will hereafter be described with reference to the accompanying drawings, wherein like reference numerals denote like elements, and:

FIG. 1 is a side view of a wire frame member of a first non-limiting embodiment of a fishing bait of the present invention;

FIG. 2 is a side view of the wire frame member of FIG. 1 with a buoyancy device and spinner blades attached;

FIG. 3 is a side view of the first embodiment of the fishing bait;

FIG. 4 is a perspective view of a wire frame member of a second non-limiting embodiment of the fishing bait of the present invention;

FIG. 5 is a perspective view of the wire frame member of FIG. 4 with a buoyancy device and spinner blades attached;

FIG. 6 is a perspective view of the second embodiment of the fishing bait;

FIG. 7 is a side view of a wire frame member of a third non-limiting embodiment of the fishing bait of the present invention;

FIG. 8 is a side view of the wire frame member of FIG. 7 with a buoyancy device and a spinner blade attached;

FIG. 9 is a side view of the third embodiment of the fishing bait;

FIG. 10 is a side view of a wire frame member of a fourth non-limiting embodiment of the fishing bait of the present invention;

FIG. 11 is a side view of the wire frame member of FIG. 10 with a buoyancy device and a spinner blade attached;

FIG. 12 is a side view of the fourth embodiment of the fishing bait;

FIG. 13 is a side view of a wire frame member of a fifth non-limiting embodiment of the fishing bait of the present invention;

FIG. 14 is a side view of the wire frame member of FIG. 13 with a buoyancy device attached; and

FIG. 15 is a side view of the fifth embodiment of the fishing bait.

### DETAILED DESCRIPTION OF THE PREFERRED EMBODIMENTS

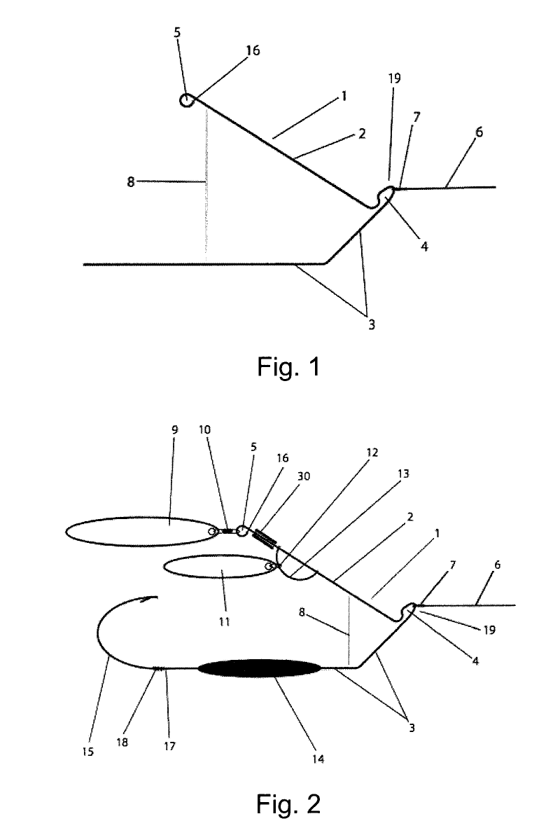

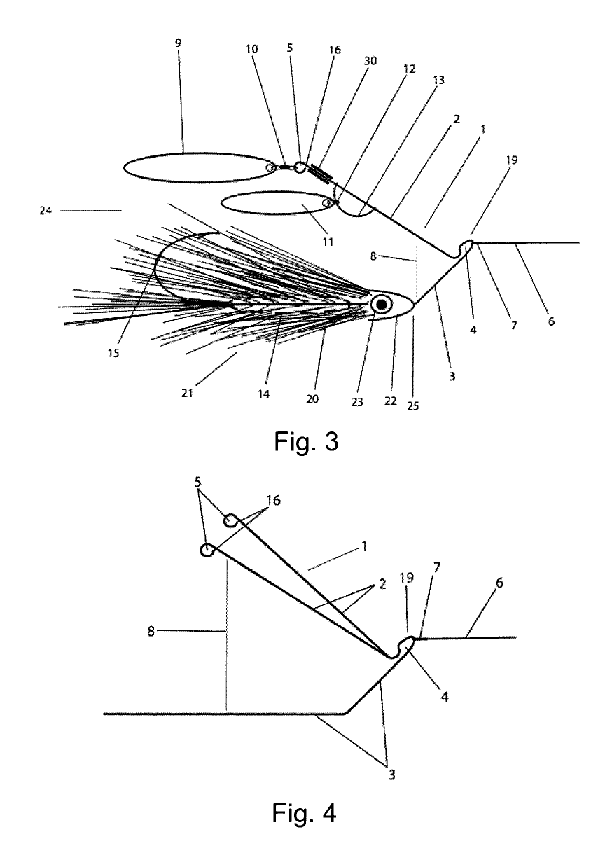

The invention generally relates to a fishing bait that includes components of both lures and flies. It should be noted that the figures illustrate various degrees of completion of different embodiments of the fishing bait. For example, FIG. 1 illustrates a frame member 1 from which a completed assembly of a first embodiment of the fishing bait 24 is created. The fishing bait is preferably sold to an end user as a completed assembly as shown in FIGS. 3, 6, 9, 12, or 15.

Referring to FIGS. 1-3, a first non-limiting embodiment of the fishing bait 24 includes a frame member 1, such as a shaped metal wire, that is a general v-shape 8. The frame member 1 is also a flat and keel-shaped component to advantageously help the fishing bait 24 exhibit proper motion in water. The frame member 1 includes an upper leg 2, a lower leg 3 opposite the upper leg 2, and an eye 4 at a connection point 19 adjacent to the legs 2 and 3. The eye 4 connects to a knot 7 of a fishing line 6, or the fishing line 6 is connected to the eye 4 in another well-known manner.

Referring now to FIGS. 2 and 3, several components connect to the upper leg 2 of the frame member 1. Specifically, one or more lure provisions 9, such as a spinner blade or the like, connect via a rotatable assembly 10 to an eye 5 at a distal end 16 of the upper leg 2. If the lure provision 9 is a spinner blade, it may be any spinner blade known in the art and may be of various shapes, colors, and compositions. One or more additional lure provisions 11, such as a spinner blade or the like, also connect to the upper leg 2 via a movable clevis 13 and a ring 12 that allow the lure provision 11 to rotate freely on the upper leg 2. If the lure provision 11 is a spinner blade, it may be identical to the lure provision 9, or alternatively, the lure provision 11 may be of a different color, size, composition, and shape. A spacing device 30 connects to the upper leg 2 to prevent the movable clevis 13 from sliding up to the eye 5, thereby allowing the lure provision 11 to rotate and wobble freely and not interfere with the movement of the lure provision 9.

Referring to FIGS. 2 and 3, several components connect to the lower leg 3 of the frame member 1. Specifically referring to FIG. 3, an imitation device 21 is constructed on the lower leg 3 of the frame member 1. The imitation device 21 is constructed using fly tying materials 20 and fly tying techniques. The imitation device 21 attracts fish by closely mimicking an actual food item, such as a minnow, leech, squid, or the like, or otherwise being attractive through size, shape, color, and/or motion in water. An eye 23 is painted, cemented, or otherwise formed on the head 22. A head 22 of the imitation device 21 is constructed at the anterior end 25 of the imitation device 21 using appropriate fly tying techniques. In addition, the imitation device 21 is constructed on the frame member 1 to complement the flat and keel-shaped frame member 1. The keel-shape of the frame member 1 advantageously helps the fishing bait 24 exhibit proper motion in water.

Referring again to FIGS. 2 and 3, a buoyancy control device 14 connects to the lower leg 3. The buoyancy control device 14 may be any buoyancy control device known in the art and may be of various sizes, shapes, colors, and/or compositions. The buoyancy control device 14 may also be made of any appropriate substance that causes the spinner bait to sink, float, or remain neutrally buoyant. Various means may be used to connect the buoyancy control device 14 to the lower leg 3, such as casting, clamping, affixing with wire, thread or various cements, or by any other method known in the art. The buoyancy control device 14 is positioned on the lower leg 3 so that the imitation device 21 encapsulates or otherwise conceals the buoyancy control device 14. A paint or other color treatment may be used so that the buoyancy control device 14 becomes a part of the imitation device 21. However, the buoyancy control device 14 remains separate from the head 22 of the imitation device 21, and as a result, the weight of the fishing bait 24 is centered in the imitation device 21 behind the head 22. This positioning of the buoyancy control device 14 helps the fishing bait 24 exhibit proper motion in water.

A hook 15 including one or more points connects to a distal end 17 of the lower leg 3. An attachment point 18 between the hook 15 and the distal end 17 may be a welded or soldered joint, a wire wrapped around the end 17 and the hook 15 and held by tabs on the two components, or a loop of the end 17 through a hook eye of the hook 15. The hook 15 is preferably oriented to complement the flat and keel-shaped frame member 1.

As an alternative, one or more additional lure provisions, such as beads, sleeves, rattles, lips, and the like, may connect one or both of the upper leg 2 and the lower leg 3. The lure provision may be may be any lure provision known in the art and may be of various sizes, shapes, colors, and compositions. In addition, one or more additional lure provisions, such as spinner blades, wobble blades, other blade-like devices, beads, sleeves, rattles, lips, and the like, may connect to the hook 15. Further still, multiple hooks 15 may connect to the frame member 1.

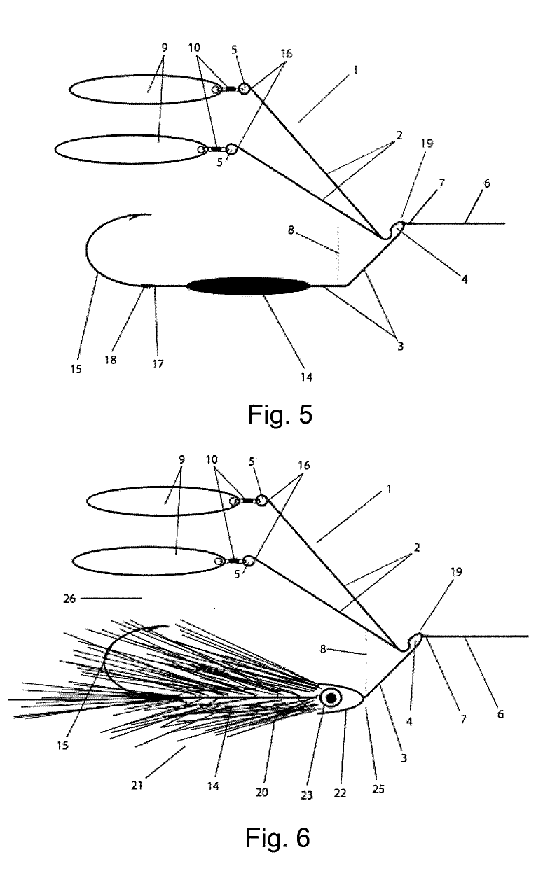

Referring now to FIGS. 4-6, a second non-limiting embodiment of the fishing bait 26 includes a frame member 1 that is a general v-shape 8. The frame member 1 includes two upper legs 2 and a single lower leg 3 with an eye 4 at a connection point 19 adjacent to the legs 2 and 3. The eye 4 is located at the juncture of the upper legs 2 and the lower leg 3. The eye 4 connects to a knot 7 of a fishing line 6, or the fishing line 6 is connected to the eye 4 in another well-known manner. The upper legs 2 may have identical shapes and dimensions and are separated such that they form a general v-shape when viewed from above. Referring to FIGS. 5 and 6, lure provisions 9, such as spinner blades, beads, sleeves, rattles, lips, or the like, each connect via a rotatable assembly 10 to an eye 5 at a distal end 16 of one of the upper legs 2. Other components, such as a buoyancy control device 14 and an imitation device 21, connect to the lower leg 3 as described in conjunction with the first embodiment of the fishing bait 24.

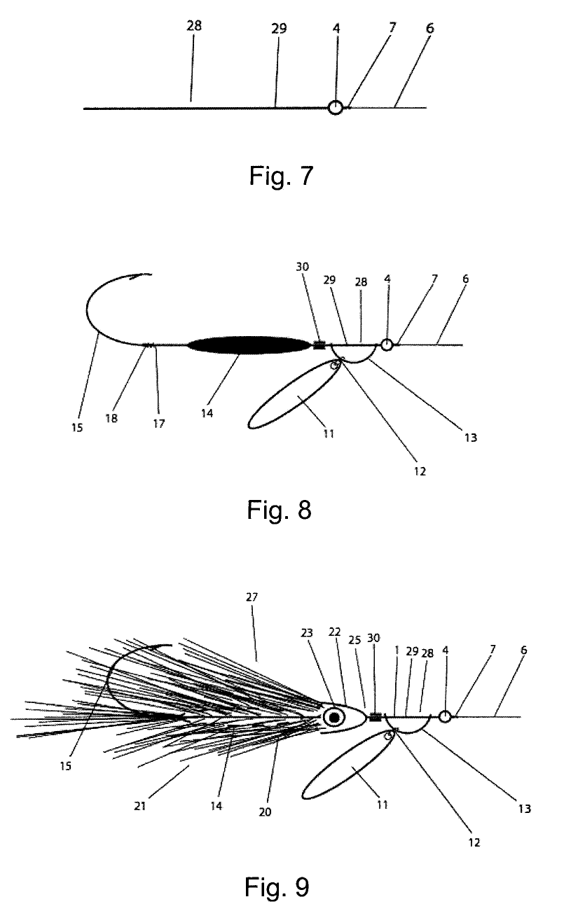

Referring now to FIGS. 7-9, a third non-limiting embodiment of the fishing bait 27 includes a frame member 28, such as a metal wire, with a straight leg 29. The frame member 28 includes an eye 4 as a connection point to a knot 7 of a fishing line 6, or the fishing line 6 is connected to the eye 4 in another well-known manner. A hook 15 including one or more points connects to a distal end 17 of the straight leg 29. An attachment point 18 between the hook 15 and the distal end 17 may be a welded or soldered joint, a wire wrapped around the end 17 and the hook 15 and held by tabs on the two components, or a loop of the end 17 through a hook eye of the hook 15. A buoyancy control device 14 and an imitation device 21 connect to the straight leg 3 as described in conjunction with the first embodiment of the fishing bait 24. Referring to FIGS. 8 and 9, one or more lure provisions 11, such as spinner blades, beads, sleeves, rattles, lips, or the like are rotatably connected to the frame member 28 by a movable clevis 13 and a ring 12. The movable clevis 13 connects to the frame member 28 between a spacing device 30 proximate the imitation device 21 and the eye 4 such that the lure provision 11 may rotate freely on the frame member 28.

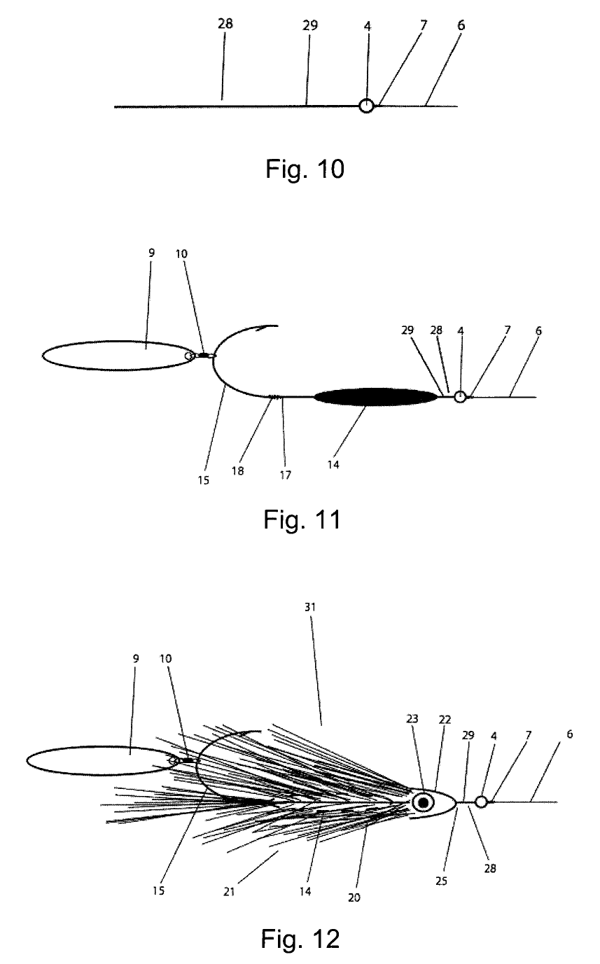

Referring now to FIGS. 10-12, a fourth non-limiting embodiment of the fishing bait 31 generally includes the same components as the third embodiment of the fishing bait 27. However, the fourth embodiment of the fishing bait 31 includes a lure provision 9 proximate the hook 15 instead of the eye 4. Specifically, a lure provision 9, such as a spinner blade, beads, sleeves, rattles, lips, or the like is connected via a rotatable assembly 10 to the hook 15.

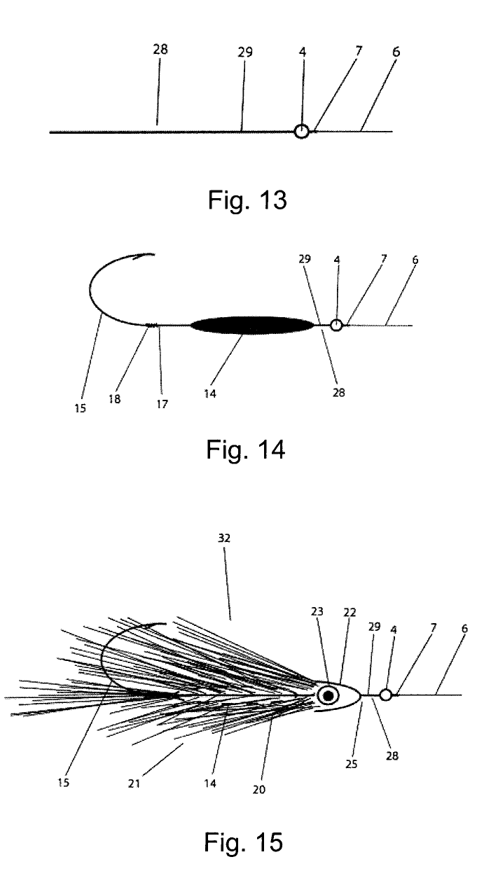

Referring now to FIGS. 13-15, a fifth non-limiting embodiment of the fishing bait 32 generally includes the same components as the third and fourth embodiments of the fishing bait 26 and 27. However, the fifth embodiment of the fishing bait 32 does not include a lure provision connected to either the frame member 28 or the hook 15.

As described above, the general shape and positioning of some components of the fishing bait advantageously permit the fishing bait to exhibit proper motion in water. As a result, a user does not need to “tune” the fishing bait of the present invention in order to prevent the fishing bait from moving erratically in water.

Several non-limiting embodiments of the invention has been described in considerable detail. Many modifications and variations to the embodiments described will be apparent to those of ordinary skill in the art. Therefore, the invention should not be limited to the embodiments described, but should be defined by the claims that follow.

We claim:

1. A fishing bait, comprising:
a frame member including a connection point connectable to a fishing line;
at least one hook connected to the frame member, the at least one hook including at least one point;
an imitation device for attracting fish, the imitation device including a head comprising fly tying materials connected to the frame member; and
a buoyancy control device connected to the frame member proximate to and separate from the head of the imitation device.

2. The fishing bait of claim 1, wherein the frame member further includes a first leg adjacent to the connection point to which the at least one hook, the buoyancy control device, and the imitation device connect, and wherein the frame member further includes a second leg adjacent to the connection point and opposite the first leg to provide a v-shaped frame member.

3. The fishing bait of claim 2, further comprising at least one lure provision connected to the second leg.

4. The fishing bait of claim 1, wherein the imitation device includes a portion adjacent the head that conceals the buoyancy device.

5. The fishing bait of claim 1, further comprising at least one lure provision connected to the frame member.

6. The fishing bait of claim 5, wherein the at least one lure provision is rotatable relative to the frame member.

7. The fishing bait of claim 5, wherein the at least one lure provision is selected from a group consisting of a spinner blade, a wobble blade, a bead, a rattle, and a lip.

8. The fishing bait of claim 1, wherein the frame member is keel-shaped.

9. The fishing bait of claim 1, wherein the at least one hook connects to a distal end of the frame member opposite the connection point.

10. A fishing bait, comprising:
a frame member including a connection point connectable to a fishing line, and the frame member having a keel-shape;
at least one hook connected to the frame member, the at least one hook including at least one point;
at least one lure provision connected to the frame member; and
an imitation device for attracting fish, the imitation device including fly tying materials and being shaped to complement the keel-shape of the frame member.

11. The fishing bait of claim 10, wherein the at least one lure provision is selected from a group consisting of a spinner blade, a wobble blade, a bead, a rattle, and a lip.

12. The fishing bait of claim 10, further comprising a buoyancy control device connected to the frame member.

13. The fishing bait of claim 12, wherein the imitation device is disposed proximate to the buoyancy control device so that the imitation device conceals the buoyancy device.

14. The fishing bait of claim 10, wherein the imitation device includes a head comprising fly tying materials.

15. A fishing bait, comprising:
a frame member including an eye connectable to a fishing line, the frame member including a distal end opposite the eye, and the frame member having a keel-shape;
at least one hook connected to the distal end of the frame member, the at least one hook including at least one point;
an imitation device for attracting fish, the imitation device including a head comprising fly tying materials connected to the frame member; and
a buoyancy control device connected to the frame member proximate to and separate from the head of the imitation device.

16. The fishing bait of claim 15, further comprising at least one lure provision connected to the frame member.

17. The fishing bait of claim 16, wherein the at least one lure provision is rotatable relative to the frame member.

18. The fishing bait of claim 15, wherein the at least one lure provision is selected from a group consisting of a spinner blade, a wobble blade, a bead, a rattle, and a lip.

19. The fishing bait of claim 15, wherein the imitation device includes a portion adjacent the head that conceals the buoyancy device.
